(19) United States
(12) Patent Application Publication
(10) Pub. No.: US 2021/0209944 A1
(43) Pub. Date: Jul. 8, 2021

(54) STREET-BOUND EMERGENCY VEHICLE WARNING LIGHTING SYSTEM

(71) Applicants: Daven Ray-Jean Segura, (US); Carlos Juan Dioso Morton, III, (US); Mario Orendain, JR., Riverside, CA (US); Efren Doroteo, San Bernardino, CA (US)

(72) Inventors: Daven Ray-Jean Segura, (US); Carlos Juan Dioso Morton, III, (US); Mario Orendain, JR., Riverside, CA (US); Efren Doroteo, San Bernardino, CA (US)

(21) Appl. No.: 16/735,570

(22) Filed: Jan. 6, 2020

(51) Int. Cl. G08G 1/095; G08G 1/07

(52) U.S. Cl. CPC G08G 1/095; G08G 1/07

(57) ABSTRACT

A street-bound emergency vehicle warning lighting system is disclosed. Such a system can provide drivers and pedestrians ample time to safely pull over, and allow an emergency vehicle to pass, reducing response times of emergency vehicles and increasing public safety.

### CROSS-REFERENCE TO RELATED APPLICATION(S)

This application claims priority to U.S. Provisional Application No. 62/789,868 filed 8 Jan. 2019, entitled A Street-bound Emergency Vehicle Warning Lighting System, the disclosure of which is hereby expressly incorporated by reference herein in its respective entirety.

### BACKGROUND

### Field

This present disclosure relates to the field of road safety and embodiments relate to systems or methods of managing traffic.

### Description of the Related Art

With the current state of the art, drivers become aware of an oncoming emergency vehicle through the emergency vehicle's siren and warning lights. The siren can be drowned out by car speakers, traffic noise and pedestrians wearing earbuds. The current emergency vehicle warning system of a siren and lights doesn't provide enough time to react and often leaves drivers and pedestrians confused as to where the emergency vehicle is located and what action to take. This confusion increases response time for the emergency vehicle and increases risk for drivers, pedestrians and the emergency vehicle.

### SUMMARY

In some implementations, the present disclosure relates to giving drivers and pedestrians ample time to safely get out of the path of emergency vehicles and allowing emergency vehicles to pass by quickly and safely.

The present disclosure solves the problem of drivers and pedestrians receiving warning signals from approaching emergency vehicles when they are very close to them, causing the drivers to become confused as to where the emergency vehicle is located and what action to take. Using the present disclosure, drivers and pedestrians become aware of an oncoming emergency vehicle using raised pavement markers with LED or comparable lights that are activated in advance of the arrival of the approaching emergency vehicle or vehicles by the approaching emergency vehicle or vehicles. The present disclosure allows drivers and pedestrians to clear the path of an oncoming emergency vehicle and avoid slowing the response time of that emergency vehicle and increasing public safety.

The present disclosure is for “Light the Way,” a raised pavement marker which provides increased awareness to pedestrians of incoming emergency vehicles. The “Light the Way” raised pavement marker comes equipped with multiple LED lights, for example 8, that are hardwired to a battery pack inside of the raised pavement marker. These LED lights are arranged to have a portion of the lights on the front of the raised pavement marker, and a portion on the opposite end. In addition to the LED lights, the raised pavement marker also contains a battery pack, a solar panel and a circuit board containing a microprocessor that controls the LED lights and a communications component that transmits wi-fi and bluetooth signals. The coding that accompanies the microprocessor programs the LED lights to activate when the pavement marker is triggered remotely. The raised pavement marker's LED lights are activated when an oncoming emergency vehicle is on its way to a destination on a route that will pass one or more of the raised pavement markers. Using a code and the predicted GPS route(s) of the emergency vehicle, the raised pavement markers that are on the path or predicted paths of the first responders' vehicle or vehicles will activate, lighting up to provide advance warning to drivers or pedestrians. These illuminated LED lights, for example blue lights, will alert drivers and pedestrians of an oncoming emergency vehicle. In response, the pedestrians will transit to the sides of the roads and vehicles will promptly pull over the side of the road, allowing the first responder to pass by without interruption. At least one raised pavement marker in a group of raised pavement markers has a communication system including a receiver and transmitter to communicate with a GPS system in one or more emergency vehicles. This GPS system uses WIFI or Bluetooth or a similar communication link to connect with the nearby raised pavement marker from an emergency vehicle, it will send that signal to the other markers nearby that are on the path of the oncoming emergency vehicle. These raised pavement markers will receive the signal and its microprocessor will turn on the warning lights, for example, blue lights. This disclosure is for a light-based system that will alert drivers and pedestrians of an oncoming emergency vehicle. This gives the drivers and pedestrians a visual cue of an oncoming emergency vehicle and allows drivers and pedestrians to safely and effectively move out of the way of the approaching emergency vehicle.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1a depicts a mechanical representation of an example configuration of an emergency vehicle warning lighting system.

FIG. 1b depicts the aerial and ground level view of the raised pavement maker

FIG. 1c depicts the sensor inside the raised pavement marker

FIG. 2 depicts the emergency vehicle that will initially communicate the raised pavement markers.

FIG. 3 depicts an electrical schematic of an example configuration of an emergency vehicle warning lighting system.

FIG. 4 depicts the raised pavement markers communicating with the sensor component of the emergency vehicle

FIG. 5 depicts the emergency vehicle and raised pavement marker utilizing a communication hub

FIG. 6 depicts how the communication between the emergency vehicle and the raised pavement marker creates a prediction pattern to activate nearby raised pavement markers.

FIG. 7 depicts raised pavement markers deactivating as the emergency vehicles travel farther away from said raised pavement markers.

FIG. 8 depicts the raised pavement markers being in a wireless connection between each other and being readily able to receive and respond to the approaching emergency vehicle.

FIG. 9 depicts the parts necessary to utilize the raised pavement markers.

FIG. 10 depicts the outer casing and internal components of the raised pavement markers.

FIG. 11 depicts the series of flashing lights the raised pavement marker will utilize when activated.

FIG. 12 depicts a plurality of raised pavement markers interacting and activating with each other when in response to the sensor of an emergency vehicles sensor.

FIG. 13 depicts a sensor being integral with an emergency vehicle.

FIG. 14 depicts the raised pavement marker with its energy harvesting and battery storing components.

FIG. 15 depicts a raised pavement marker interacting wirelessly with the emergency vehicle and its sensor.

FIG. 16 depicts a raised pavement marker, communication hub, and emergency vehicle interacting wirelessly.

FIG. 17 depicts a graph showcasing the order of the process commenced when activating and then deactivating the raised pavement markers.

FIG. 18 depicts a deactivation of raised pavement markers when an emergency vehicle has passed it.

FIG. 19 depicts a communication component in wireless connection with a raised pavement marker.

FIG. 20 depicts a plurality of raised pavement markers, the sensor used for communication between the raised pavement markers and other devices, and finally the printed instructions used to teach how to utilize the raised pavement markers.

### DETAILED DESCRIPTION OF SOME EMBODIMENTS

The headings provided herein, if any, are for convenience only and do not necessarily affect the scope or meaning of the claimed invention. [0011] In an embodiment, an emergency vehicle warning lighting system includes: Microprocessor/communications device, for example a RASPBERRY Pi, 1; circuit board, 2; electrical wires, 3; LEDs, 4; solar panel, 5; battery, 6; outer covering of plastic, 7; inner layer of ceramic, 8; and clear plastic windows, 9. The microprocessor/communications device, 1, performs the necessary computations according to the software stored in its memory, and then transmits commands using the metal conductors on circuit board 2 and electrical wires 3, which includes conducting power from battery, 6, to activate LEDs, 4. The system harvests energy from light using solar panel 5, which is stored in battery, 6.

Microprocessor/communications device, for example a RASPBERRY Pi, 1, receives a message over a wireless signal. This signal will go through circuit board/antenna, 2, and electrical wires 3, to activate LEDs, 4. Using programming code stored in the microprocessor/communications device, the LEDs, 4, will flash and provide a warning to drivers of vehicles and pedestrians that an emergency vehicle is approaching.

Outer covering of plastic, 7, inner layer of ceramic, 8, and clear plastic windows, 9, are used to provide strength and stability for the raised pavement marker assembly. The various plastic and ceramic materials may be used for the housing of the raised pavement marker, for example acrylonitrile butadiene styrene, which is commonly used for reflective pavement markers. Acrylonitrile butadiene styrene is a versatile and strong plastic that enables the raised pavement marker of this invention to withstand the weight and force of any vehicle that may pass over it.

The raised pavement markers can be programmed to turn their lights on or off in response to a variety of signal sources and a variety of commands, to provide warning signals for many other situations in addition to the approach of emergency vehicles, for example, to show people the location of a shared ride vehicle or where and when to board a particular train. With coding, the disclosure can also work in conjunction with other warning devices and warning systems, allowing those warning devices and warning systems to work with the lights of these raised pavement markers. For example, a raised pavement marker could serve as a communication hub to turn on or off other devices containing warning lights on curbs or poles beside a road or suspended over roads. Similarly, raised pavement markers could respond to signals received from other communication hubs placed near the pavement.

The raised pavement marker of this disclosure would be placed, like other pavement markers, according to a predetermined pattern, at intersections and on commonly congested roads at a spacing that would vary depending upon the road, traffic conditions and other relevant factors.

This disclosure is an improvement over the current state of the art. Due to the increasing popularity of earbuds for pedestrians and loud speaker systems and soundproof interiors for cars, the sound of an emergency vehicle siren is frequently drowned out, causing the pedestrians and drivers to be in harm's way. Loud noises in traffic, whether from drivers' speakers, trains, or honking, can all hinder an individual's ability to effectively hear, locate, and respond to an oncoming emergency vehicle.

This disclosure gives drivers and pedestrians preemptive visual warning signals of an oncoming first responder vehicle and will allow the driver and/or the pedestrian to safely and quickly pull out of the way before they have seen or heard the oncoming emergency vehicle. This disclosure will give drivers and pedestrians ample time to safely pull over and allow an emergency vehicle to pass, thus effectively reducing emergency vehicle response time and increasing public safety in congested areas during an emergency vehicle dispatch situation.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

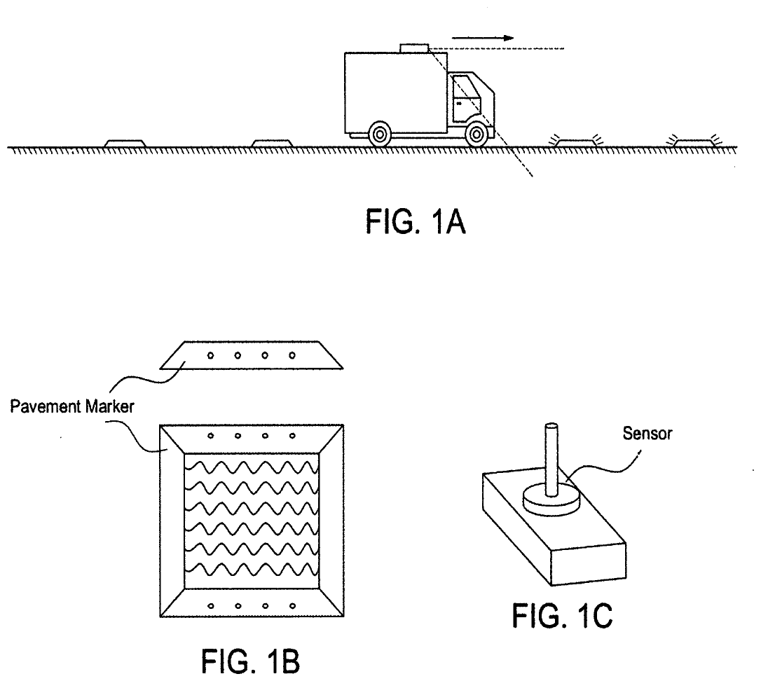

1. A system for providing enhanced signaling in response to a vehicle, said system comprising:
a plurality of raised pavement markers affixed to or embedded in a surface of a road, each raised pavement marker comprising a light and a communication component, said raised pavement marker configured to provide a visual output in response to a signal being received by the communication component which comprises of a wi-fi and bluetooth module built into the microprocessor of the unit; and
a sensor configured to detect or provide location and direction of travel of said vehicle, said sensor further configured to determine a selected area toward which said vehicle is likely traveling and to send the respective signal which contains the information previously collected to said communication component of each of one or more of said raised pavement markers in said selected area, such that a person or a vehicle in or close to said selected area is provided with a warning with said light of each said one or more of said raised pavement markers as seen in FIG. 1 of the drawings.

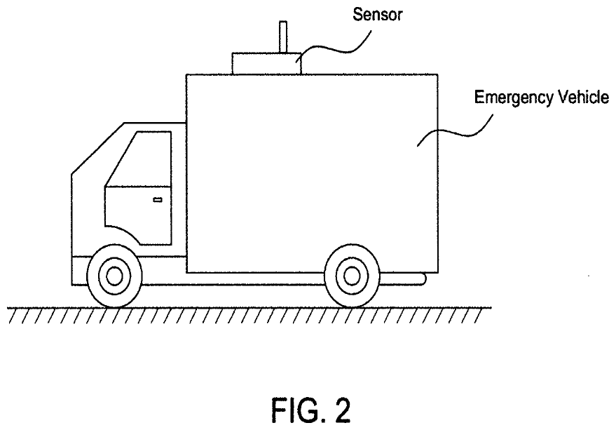

2. The system of claim 1, wherein the vehicle is an emergency vehicle, and the sensor is integral with the emergency vehicle as seen in FIG. 2 of the drawings.

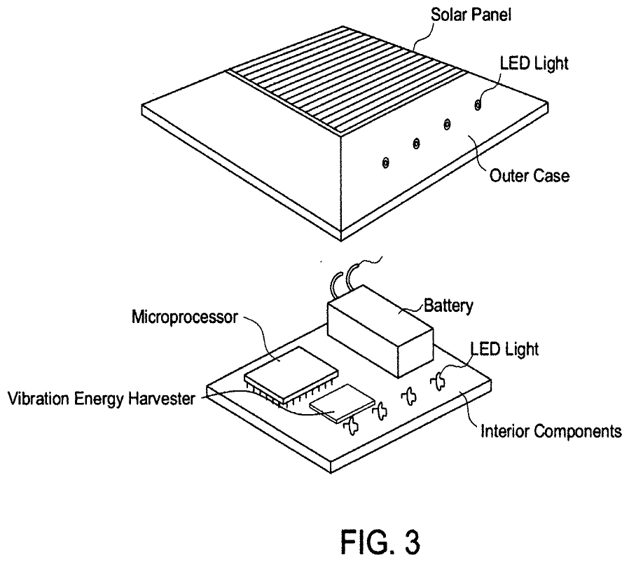

3. The system of claim 1, wherein said raised pavement markers comprise a solar panel and/or vibration energy harvesting component and an energy storage component as seen in FIG. 3 of the drawings.

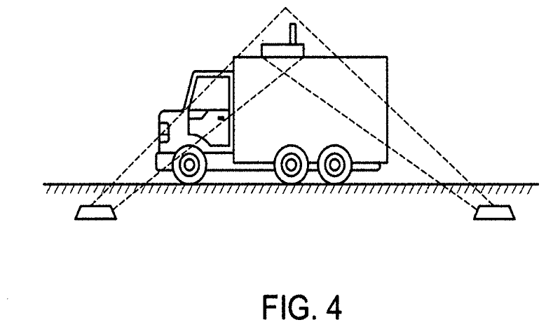

4. The system of claim 1, wherein said sensor is in wireless connection with said communication component as seen in FIG. 4 of the drawings.

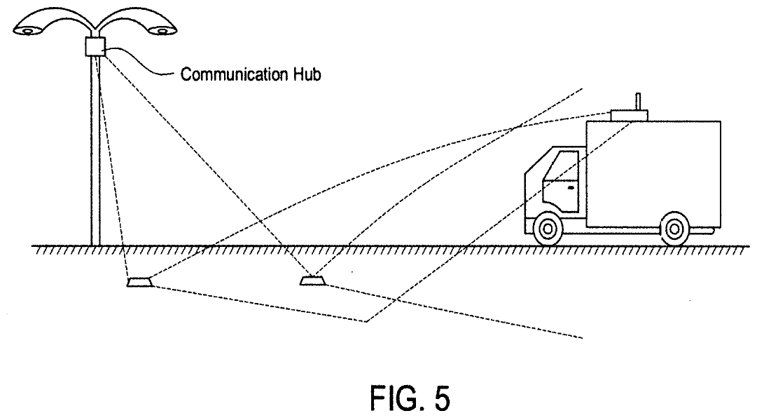

5. The system of claim 1, wherein said sensor is in wireless connection with a communication hub, which is in wired and/or wireless connection with said communication component as seen in FIG. 5 of the drawings.

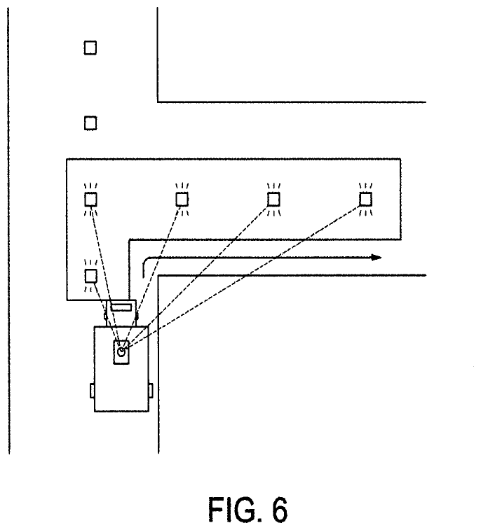

6. The system of claim 1, wherein said sensor predicts the most likely path or paths of travel of the emergency vehicle, determines which raised pavement markers to illuminate and sends a signal to only the raised pavement markers that are in close proximity to the predicted path or paths of travel at a predetermined amount of time prior to when the emergency vehicle is predicted to be in close proximity to said raised pavement markers as seen in FIG. 6 of the drawings.

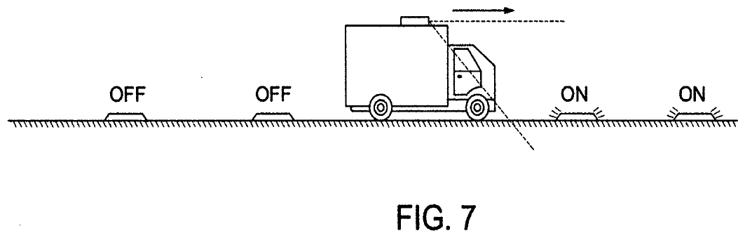

7. The system of claim 1, wherein a further step includes determining from the sensor that the emergency vehicle has passed said pedestrian or vehicle and sending a signal to the communication unit of one or more raised pavement markers in close proximity with said pedestrian or vehicle to de-illuminate one or more of the raised pavement markers as seen in FIG. 7 of the drawings.

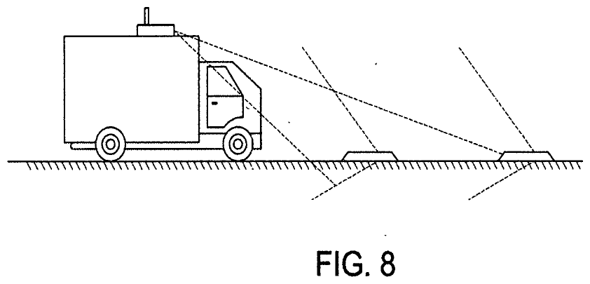

8. The system of claim 1, wherein said communication component is in wireless connection with communication components in one or more other raised pavement markers or other signaling devices as seen in FIG. 8 of the drawings.

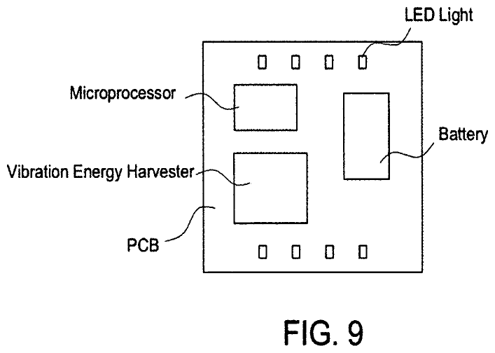

9. The system of claim 1, further comprising a microprocessor configured to control at least some of operations of the raised pavement markers and communicate with the sensor as seen in FIG. 9 of the drawings.

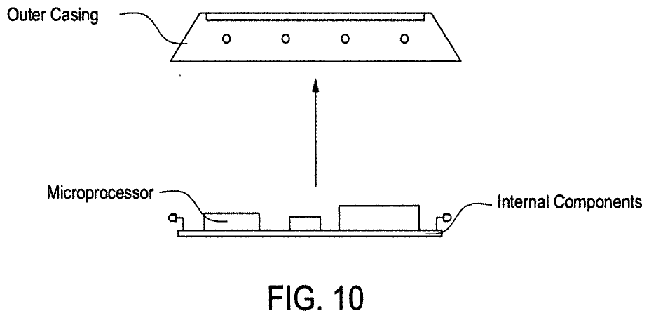

10. The system of claim 9, wherein the microprocessor is implemented as a part of each raised pavement marker as seen in FIG. 10 of the drawings.

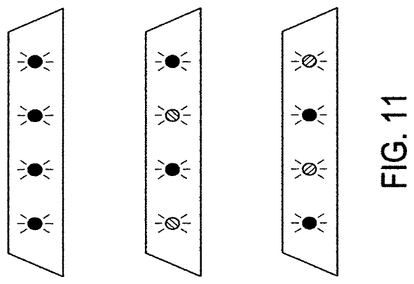

11. The system of claim 1, wherein the visual output includes one or more of illumination of light, color change of light, and flashing of light as seen in FIG. 11 of the drawings.

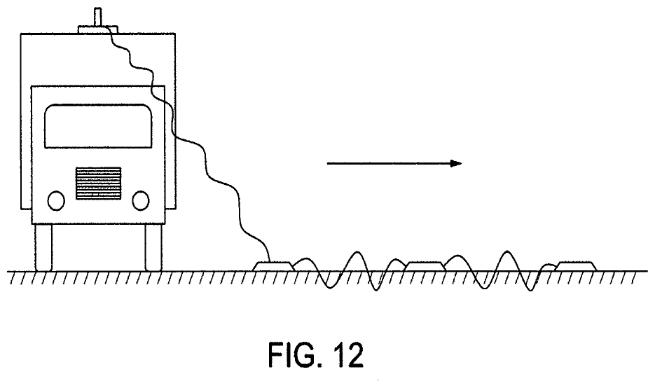

12. A method for providing enhanced signaling in response to a vehicle, comprising the following steps:
providing a plurality of raised pavement markers affixed to or embedded in a surface of a road, each raised pavement marker comprising a light and a communication component, said raised pavement marker configured to provide a visual output in response to a signal being received by the communication component; and
providing a sensor configured to detect or provide location and direction of travel of said vehicle, said sensor further configured to determine a selected area toward which said vehicle is likely traveling and to send the respective signal which contains the information previously collected to said communication component of each of one or more of said raised pavement markers In said selected area, such that a person or a vehicle in or close to said selected area is provided with a warning with said light of each of said one or more of said raised pavement markers as seen in FIG. 12 of the drawings.

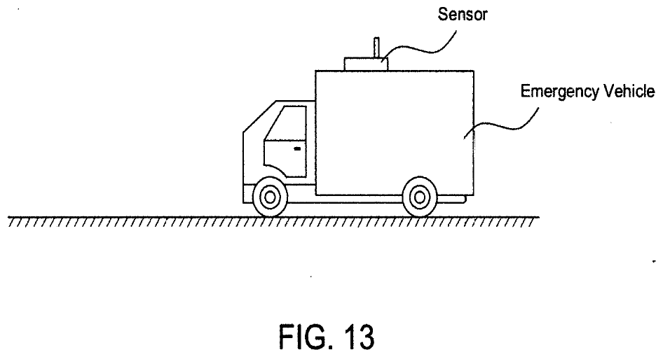

13. The method of claim 12, wherein the vehicle is an emergency vehicle, and the sensor is integral with the emergency vehicle as seen in FIG. 13 of the drawings.

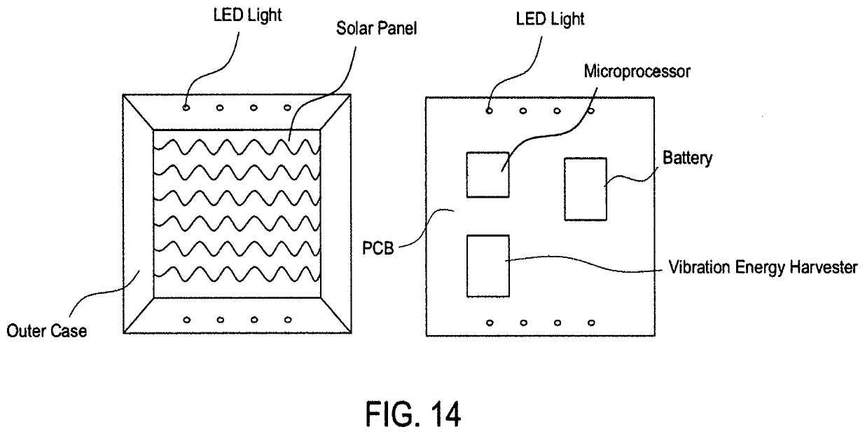

14. The method of claim 12, wherein said raised pavement markers comprise a solar panel and/or vibration energy harvesting component and an energy storage component as seen in FIG. 14 of the drawings.

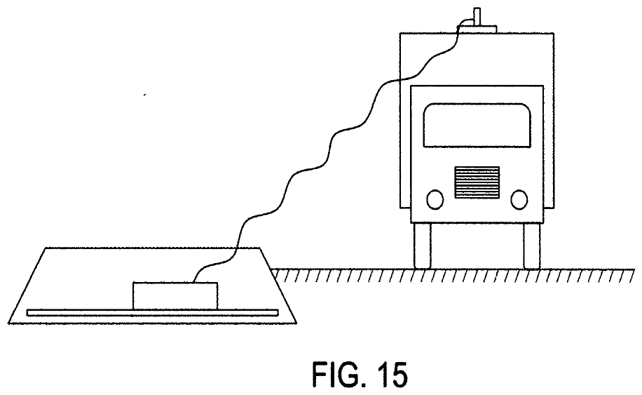

15. The method of claim 12, wherein said sensor is in wireless connection with said communication component as seen in FIG. 15 of the drawings.

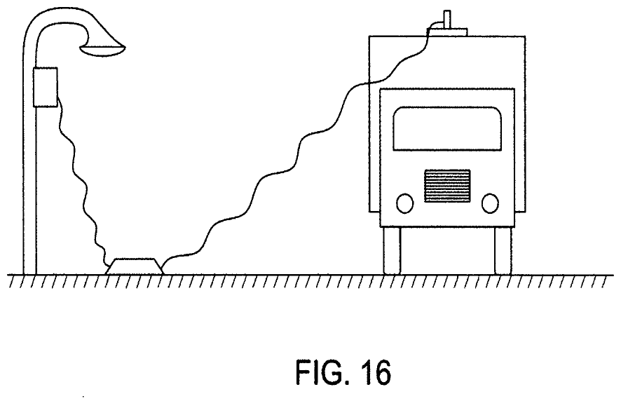

16. The method of claim 12, wherein said sensor is in wireless connection with a communication hub, which is in wired and/or wireless connection with said communication component as seen in FIG. 16 of the drawings.

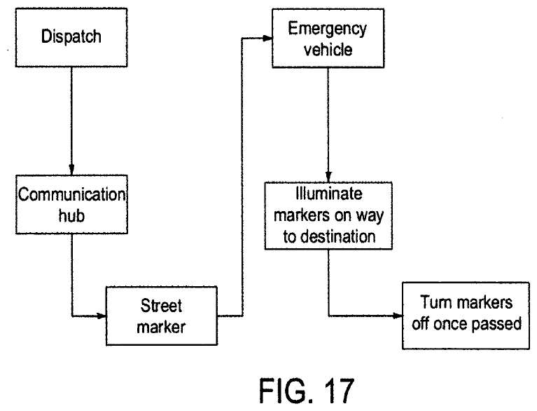

17. The method of claim 12, wherein said sensor predicts the most likely path or paths of travel of the emergency vehicle, determines which raised pavement markers to illuminate and sends a signal to only the raised pavement markers that are in close proximity to the predicted path or paths of travel at a predetermined amount of time prior to when the emergency vehicle is predicted to be in close proximity to said raised pavement markers as seen in FIG. 17 of the drawings.

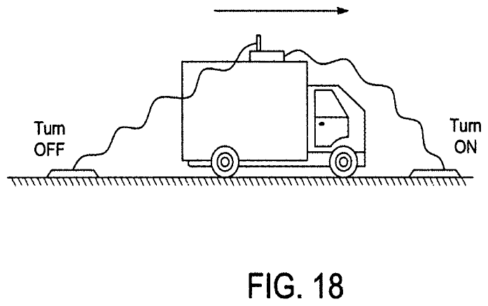

18. The method of claim 12, wherein a further step includes determining from the sensor that the emergency vehicle has passed said pedestrian or vehicle and sending a signal to the communication unit of one or more raised pavement markers in close proximity with said pedestrian or vehicle to de-illuminate one or more of the raised pavement markers as seen in FIG. 18 of the drawings.

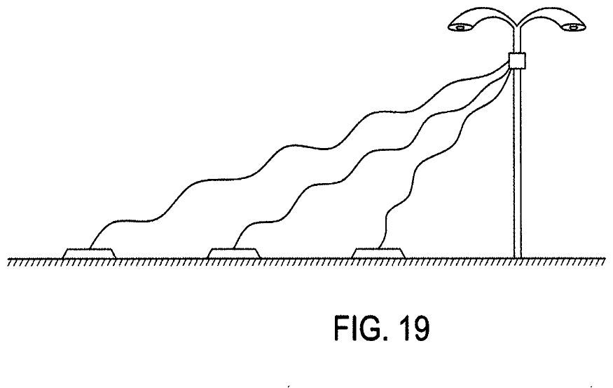

19. The method of claim 12, wherein said communication component is in wireless connection with communication components in one or more other raised pavement markers or other signaling devices as seen in FIG. 19 of the drawings.

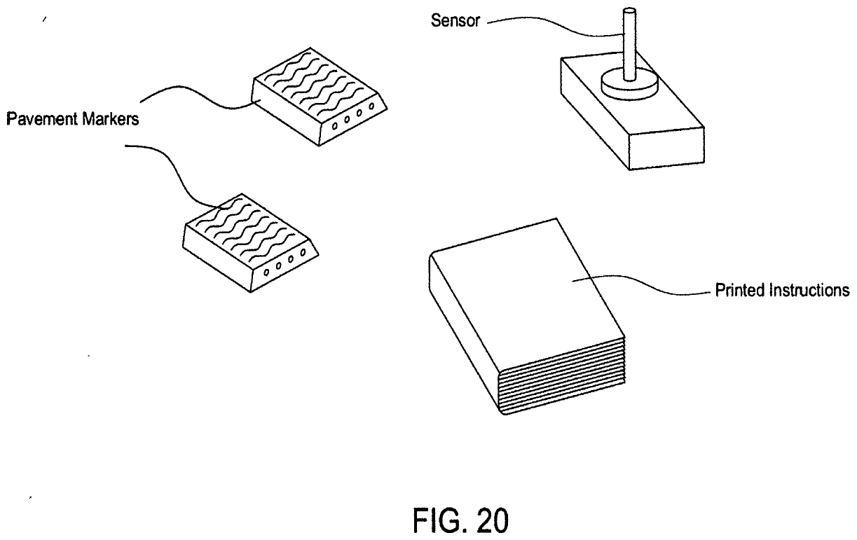

20. A kit for providing enhanced signaling in response to a vehicle, said kit comprising:
a plurality of raised pavement markers, each configured to be affixed to or embedded in a surface of a road, each raised pavement marker comprising a light and a communication component, said raised pavement marker configured to illuminate, change color and/or flash the light in response to a signal being received by the communication component;
a sensor configured to detect or provide location and direction of travel of said vehicle, said sensor further configured to determine a selected area toward which said vehicle is likely traveling and sends the respective signal to said communication component of each of one or more of said raised pavement markers when affixed or embedded in said selected area, such that a person or a vehicle in or close to said selected area is provided with a warning with said light of each of said one or more of said raised pavement markers; and
a printed instruction configured to allow implementation and use of said raised pavement markers and said sensor as seen in FIG. 20 of the drawings.
